(19) United States
(12) Patent Application Publication
(10) Pub. No.: US 2010/0304229 A1
(43) Pub. Date: Dec. 2, 2010

(54) PROTON CONDUCTOR, ELECTROCHEMICAL CELL AND METHOD OF MANUFACTURING PROTON CONDUCTOR

(76) Inventors: Naoki Ito, Kanagawa-ken (JP); Hiroshige Matsumoto, Fukuoka (JP); Sachio Okada, Fukuoka (JP); Tatsumi Ishihara, Fukuoka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/593,054

(22) PCT Filed: Mar. 25, 2008
(86) PCT No.: PCT/JP2008/056278

§ 371 Date: Mar. 23, 2010

(30) Foreign Application Priority Data
Mar. 27, 2007 (JP) 2007-082999

(51) Int. Cl. H01M 8/06

(52) U.S. Cl. 429/409

(57) ABSTRACT

A proton conductor includes a main constituent element. A part of the main constituent element is substituted by a transition metal. Valence of the transition metal is variable between valence of the main constituent element and valence lower than the valence of the main constituent element.

### CROSS-REFERENCE TO RELATED APPLICATIONS

This application is a national phase application of International Application No. PCT/JP2008/056278, filed Mar. 25, 2008, and claims the priority of Japanese Application No. 2007-082999, filed Mar. 27, 2007, the contents of both of which are incorporated herein by reference.

### TECHNICAL FIELD

This invention generally relates to a proton conductor, an electrochemical cell and a method of manufacturing a proton conductor.

### BACKGROUND ART

Ion conductor is used for an electrochemical cell such as a battery cell, a sensor or a fuel cell. A solid oxide electrolyte is used for the ion conductor. The solid oxide electrolyte is being widely used because the solid oxide electrolyte has high ion conductivity. The solid oxide electrolyte includes a perovskite electrolyte. For example, International Publication No. WO2004/074205 (hereinafter referred to as Document 1) discloses a perovskite electrolyte including chromium, manganese, iron or ruthenium as a constituent element.

### DISCLOSURE OF THE INVENTION

However, the ion conductor disclosed in Document 1 is an electron-proton mixed conductor. Therefore, high proton conductivity may not be obtained.

The present invention provides a proton conductor and an electrochemical cell that have high proton conductivity and a method of manufacturing a proton conductor that has high proton conductivity.

According to another aspect of the present invention, there is provided a method of manufacturing an electrolyte for a proton conductive type fuel cell including a generation step of generating the electrolyte under an oxidation condition in which oxygen partial pressure is 0.01 atm or higher, a part of a main constituent element of the electrolyte being substituted by a transition metal, valence of the transition metal being variable between a first valence that is the same as that of the main constituent element and a second valence that is lower than the first valence, the oxidation condition being a condition in which the valence of the transition metal is a value more than the second valence and less than the first valence.

With the method, the valence of the transition metal is larger than the second valence when the proton conductor is generated. Therefore, the transition metal tends to have the second valence when the proton conductor is used. Consequently, the proton conductor has high proton conductivity.

The generation step may be a step of baking the proton conductor under an atmosphere including pressured oxygen or under an atmosphere including pressured air.

The generation step may include an oxygen treatment step in which the proton conductor is subjected to an oxygen treatment.

The oxygen treatment may be a treatment in which the proton conductor is subjected to an oxygen atmosphere. The oxygen treatment may be a treatment in which an anodic voltage is applied to the proton conductor under an oxygen atmosphere. In this case, the transition metal tends to have the second valence under an oxygen atmosphere such as air atmosphere. Therefore, the proton conductor has high proton conductivity under the oxygen atmosphere such as the air atmosphere.

The electrolyte may have AB₍₁₋ₓ₎MₓO₃ perovskite structure, the B being the main constituent element, the M being the transition metal, the x being a value of 0.05 to 0.15. The electrolyte may be one of SrZrRu, SrZrTbRu and SrZrMn.

### EFFECTS OF THE INVENTION

According to the present invention, a proton conductor has high proton conductivity.

### BRIEF DESCRIPTION OF THE DRAWINGS

FIG. 1A and FIG. 1B illustrate a proton conductor in accordance with a first embodiment of the present invention;

FIG. 2 illustrates a schematic cross sectional view of a fuel cell in accordance with a second embodiment;

FIG. 3 illustrates a schematic cross sectional view of a hydrogen permeable membrane fuel cell in accordance with a third embodiment;

FIG. 4 illustrates a hydrogen pump in accordance with a fourth embodiment;

FIG. 5 illustrates a result of XRD measuring of each proton conductor;

FIG. 6 illustrates an electrical conductivity of each proton conductor;

FIG. 7 illustrates an electromotive force measured with respect to a hydrogen concentration ell;

FIG. 8 illustrates a result of hydrogen pump measuring;

FIG. 9 illustrates measured result of oxygen nonstoichiometric amount of each proton conductor;

FIG. 10A and FIG. 10B illustrate a result of XRD measuring of each proton conductor;

FIG. 11A and FIG. 11B illustrate a result of IR measuring of each proton conductor;

FIG. 12 illustrates an electrical conductivity of each proton conductor;

FIG. 13 illustrates a result of XRD measuring of each proton conductor;

FIG. 14A and FIG. 14B illustrate a result of IR measuring of each proton conductor;

FIG. 15A and FIG. 15B illustrate an electrical conductivity of each proton conductor; and

FIG. 16 illustrates a temporal change of electrical conductivity of a proton conductor.

### BEST MODES FOR CARRYING OUT THE INVENTION

A description will now be given of best modes for carrying out the present invention.

### First Embodiment

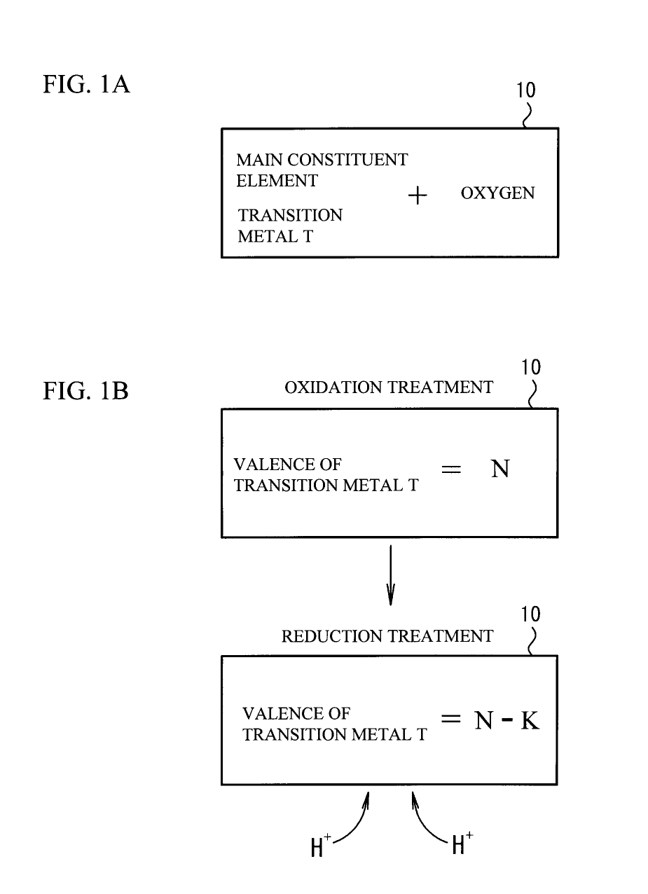

FIG. 1A and FIG. 1B illustrate an oxygen defect proton conductor 10 in accordance with a first embodiment of the present invention. As shown in FIG. 1A, the proton conductor 10 is composed of an oxide in which main constituent element is bonded to oxygen. In the proton conductor 10, a part of the main constituent element is substituted by transition metal T. Valence of the transition metal T is variable between N that is valence of the main constituent element and (N-K) that is lower than the valence N.

The valence of the transition metal T changes according to surroundings under a condition in which the proton conductor 10 has an oxide structure. As shown in FIG. 1B, the transition metal T has the valence of N that is the same as that of the main constituent element, when the proton conductor 10 is subjected to an oxidation treatment. In this case, the proton conductor 10 includes sufficient amount of oxygen.

The oxidation treatment is a treatment in which the proton conductor 10 is subjected to an oxygen atmosphere (for example, an atmosphere having an oxygen partial pressure of more than 0.01 atm). The oxidation treatment may be such as an electrical oxidation, a baking with compressed oxygen or a simple baking. The electrical oxidation is a treatment in which ion-blocking electrode is attached to the proton conductor 10 and an anodic voltage of 0.5 V to 5 V is applied to the proton conductor 10. In this treatment, the proton conductor 10 is subjected to an atmosphere having an oxygen partial pressure of approximately 10² atm to 10⁵⁰ atm. The baking with compressed oxygen is a treatment in which the proton conductor 10 is baked under a compressed oxygen atmosphere or under a compressed air atmosphere. In this treatment, the proton conductor 10 is subjected to an atmosphere having an oxygen partial pressure of approximately 1 atm to 100 atm. The simple baking is a treatment in which the proton conductor 10 is baked under non-compressed atmosphere. In this treatment, the proton conductor 10 is subjected to an atmosphere having an oxygen partial pressure of approximately 0.2 atm.

On the other hand, the valence of the transition metal T is (N-K) lower than the valence of the main constituent element, when the proton conductor 10 is subjected to a reduction treatment. That is, the valence of the transition metal T is reduced. In this case, an amount of proton according to the reduction of the valence is provided to the proton conductor 10, with the proton conductor 10 including sufficient oxygen. Consequently, the proton conductor 10 has high proton conductivity.

The reduction treatment is a treatment in which the proton conductor 10 is subjected to an atmosphere having an oxygen partial pressure that is lower than that of any oxidation treatment mentioned above. The transition metal T has the valence N that is the same as that of the main constituent element in any of the above-mentioned oxidation treatment, and has the valence (N-K) in an atmosphere having an oxygen partial pressure lower than that of the oxidation treatment. For example, the valence of the transition metal T is reduced in a reactant gas atmosphere to which a fuel cell having the proton conductor 10 as an electrolyte is subjected, or in a hydrogen atmosphere to which a hydrogen pump having the proton conductor 10 is subjected.

The valence of the transition metal T tends to be reduced when the proton conductor 10 is used, if oxidizability is high in the oxidation treatment. A description will be given of a case where the proton conductor 10 is used in a fuel cell. In this case, the valence of the transition metal T tends to be reduced when the fuel cell is used, if the valence of the transition metal T is kept to be N under a condition more oxidizing than a condition in which the fuel cell is used. Consequently, the proton conductor 10 has high proton conductivity when the fuel cell is used.

Here, a description will be given of a metal oxide electrolyte that has proton conductivity and has a fixed valence. This electrolyte has high proton conductivity when protons are introduced into the electrolyte. Generally, the protons are introduced into the electrolyte when water molecules are introduced into the electrolyte with water treatment. For example, a perovskite having a fixed valence such as SrZr_{0.8}Y_{0.2}O_{2.9} is converted into SrZr_{0.8}Y_{0.2}O₃H_{0.2} and carries out proton conductivity with water treatment.

The higher the temperature of the electrolyte is, the lower the water supply to the electrolyte is. In this case, sufficient amount of proton may not be introduced into the electrolyte. So, the electrolyte may be subjected to the water treatment with the temperature of the electrolyte being maintained low. However, the proton conductivity of the electrolyte is reduced at low temperature. Therefore, the metal oxide electrolyte having the fixed valence may not have sufficient proton conductivity both at high temperature and at low temperature.

In contrast, protons are introduced into the proton conductor in accordance with the embodiment according to the valence changing, and the introduction of the protons is balanced. In this case, it is thought that the time until the proton introduction is balanced is reduced in spite of temperature condition. The proton conductor 10 in accordance with the embodiment may carry out the proton conductivity higher than that of the metal oxide electrolyte having the fixed valence. Consequently, sufficient proton conductivity may be obtained.

The transition metal T is at least one of Ti (titanium), V (vanadium), Cr (chromium), Mn (manganese), Fe (iron), Co (cobalt), Ni (nickel), Cu (copper), Zn (Zinc), Zr (zirconium), Nb (niobium), Mo (molybdenum), Tc (technetium), Ru (ruthenium). Rh (rhodium), Pd (palladium), Ag (silver), Cd (cadmium), Hf (hafnium), Ta (tantalum), W (tungsten), Re (rhenium), Os (osmium), Ir (iridium), Pt (platinum), Au (gold), Hg (mercury), Nd (neodymium), Tb (terbium), Eu (europium), and Pr (praseodymium).

It is preferable that the proton conductor 10 has a little of electron conductivity or hole conductivity, because the protons are introduced to the proton conductor 10 relatively speedily. It is therefore preferable that the proton conductor 10 includes an electron-conductivity-giving material or a hole-conductivity-giving material. Here, the electron-conductivity-giving material is a material that brings electron conductivity to the proton conductor 10. The hole-conductivity-giving material is a material that brings hole conductivity to the proton conductor 10. Ru, Co or the like is used as the electron-conductivity-giving material or the hole-conductivity-giving material. It is therefore preferable that Ru, Co or the like is used as the transition metal T. The proton conductor 10 may have a structure in which the transition metal T is doped into an oxide such as BaZrO₃ having hole conductivity.

The proton conductor 10 may have a AB₍₁₋ₓ₎MₓO₃₋_{_{α}} type perovskite structure. In this structure, B site element corresponds to the main constituent element, and the metal M corresponds to the transition metal T. The valence of the metal M changes according to the surroundings under a condition in which the proton conductor 10 has the perovskite structure.

The valance of the A site element and the B site element is not limited. For example, the A site element may have the valence of +2, and the B site element may have the valence of +4. The A site element may have the valence of +3, and the B site element may have the valence of +3.

The metal used as the A site element is not limited. The metal having the valence of +2 used as the A site element may be Sr (strontium), Ca (calcium), Ba (barium) or the like. The A site may not be composed of a single metal element. The A site may be composed of more than one metal. The metal used as the B site element is not limited. The metal having the valence of +4 used as the B site element may be Zr (zirconium) Ce (cerium) or the like.

The metal used as the metal M is the same as that used as the transition metal T. An doping amount of the metal M is not limited. Therefore, “x” is a value of 0<x<1. It is preferable that “x” is a value of 0.05 to 0.15, because the proton conductivity of the proton conductor 10 is improved.

The metal M may be composed of more than one metal element. For example, the proton conductor 10 may be AB₍₁₋ₓ₎M1_{y}M2_{(x-y)}O₃, if the metal M includes a metal M1 and a metal M2. A metal used as the metal M1 and the metal M2 is selected from a metal group that can be used as the transition metal T. The proton conductivity of the proton conductor 10 is improved, if at least one of the metal M1 and the metal M2 is a transition metal that brings hole conductivity to the proton conductor 10.

### Second Embodiment

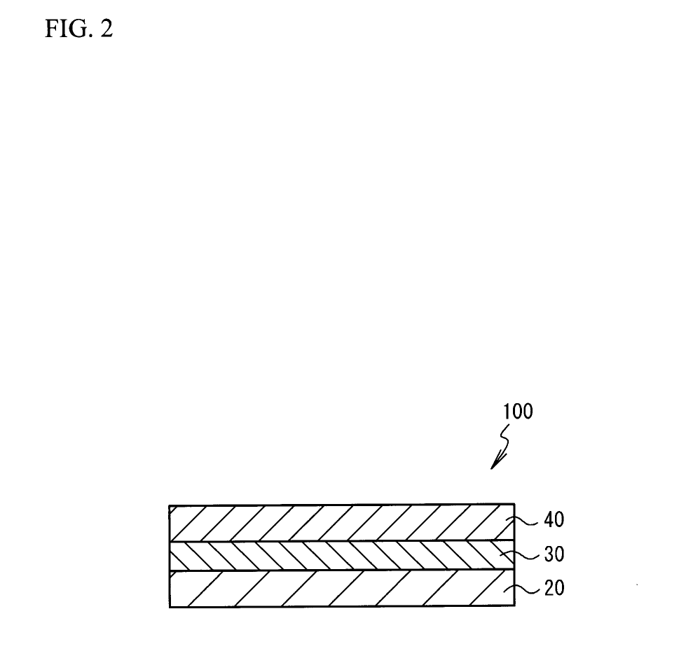

A description will be given of a fuel cell that is an example of electrochemical cells and has proton conductivity, in a second embodiment. FIG. 2 illustrates a schematic cross sectional view of a fuel cell 100 in accordance with the second embodiment. As shown in FIG. 2, the fuel cell 100 has a structure in which an anode 20, an electrolyte membrane 30 and a cathode 40 are laminated in order. The electrolyte membrane 30 is composed of the proton conductor 10 in accordance with the first embodiment.

Fuel gas including hydrogen is provided to the anode 20. Some hydrogen in the fuel gas is converted into protons and electrons. The protons are conducted in the electrolyte membrane 30 and gets to the cathode 40. Oxidant gas including oxygen is provided to the cathode 40. The protons react with oxygen in the oxidant gas provided to the cathode 40. Water and electrical power are thus generated. With the operation, the fuel cell 100 generates electrical power. Valence of a transition metal included in the electrolyte membrane 30 is reduced, because the electrolyte membrane 30 is subjected to a reducing atmosphere in the process of generating the electrical power. Therefore, the protons tend to be introduced into the electrolyte membrane 30. Therefore, the fuel cell 100 carries out high electric generation performance.

### Third Embodiment

A description will be given of a hydrogen permeable membrane fuel cell 200 that is another example of the electrochemical cells, in a third embodiment. Here, the hydrogen permeable membrane fuel cell is a type of fuel cells, and has a dense hydrogen permeable membrane. The dense hydrogen permeable membrane is a membrane composed of a metal having hydrogen permeability, and acts as an anode. The hydrogen permeable membrane fuel cell has a structure in which an electrolyte having proton conductivity is laminated on the hydrogen permeable membrane. Some of the hydrogen provided to the hydrogen permeable membrane is converted into protons. The protons are conducted in the electrolyte and gets to a cathode. The protons react with oxygen at the cathode. Electrical power is thus generated. A description will be given of details of the hydrogen permeable membrane fuel cell 200.

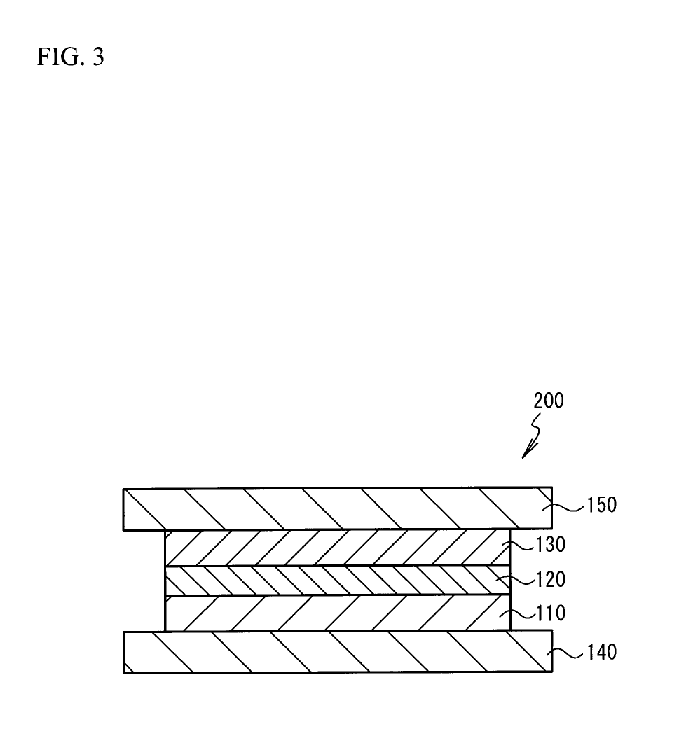

FIG. 3 illustrates a schematic cross sectional view of the hydrogen permeable membrane fuel cell 200. As shown in FIG. 3, the hydrogen permeable membrane fuel cell 200 has a structure in which an electrical generator is between a separator 140 and a separator 150, the electrical generator having a structure in which an electrolyte membrane 120 and a cathode 130 are laminated on a hydrogen permeable membrane 110 in order. In the third embodiment, the hydrogen permeable membrane fuel cell 200 operates at 300 degrees C. to 600 degrees C.

The separators 140 and 150 are made of a conductive material such as stainless steal. The separator 140 has a gas passageway to which fuel gas including hydrogen is to be provided. The separator 150 has a gas passageway to which oxidant gas including oxygen is to be provided.

The hydrogen permeable membrane 110 is made of a hydrogen permeable metal transmitting hydrogen selectively. The hydrogen permeable membrane 110 acts as an anode to which the fuel cell is to be provided, and acts as a supporter supporting and strengthening the electrolyte membrane 120. The hydrogen permeable membrane 110 is made of a metal such as palladium, vanadium, titanium or tantalum. The cathode 130 is made of a conductive material such as La_{0.6}Sr_{0.4}CoO₃ or Sm_{0.5}Sr_{0.5}CoO₃. The conductive material may support platinum.

Valence of a transition metal included in the electrolyte membrane 120 is reduced when the hydrogen permeable membrane fuel cell 200 generates electrical power, because the electrolyte membrane 120 is subjected to a reducing atmosphere. Therefore, protons tend to be introduced into the electrolyte membrane 120. Consequently, the hydrogen permeable membrane fuel cell 200 carries out high electrical generation performance.

Here, it is necessary that adhesiveness is high between the hydrogen permeable membrane 110 and the electrolyte membrane 120, in order to maintain high electrical generation efficiency of the hydrogen permeable membrane fuel cell 200. Water generation is restrained at the anode side, because the electrolyte membrane 120 is not a mixed ion conductor but a proton conductor. Therefore, a peeling is restrained between the hydrogen permeable membrane 110 and the electrolyte membrane 120, if the electrolyte membrane 120 is used. Consequently, the electrolyte in accordance with the present invention has a particular effect in the hydrogen permeable membrane fuel cell.

### Fourth Embodiment

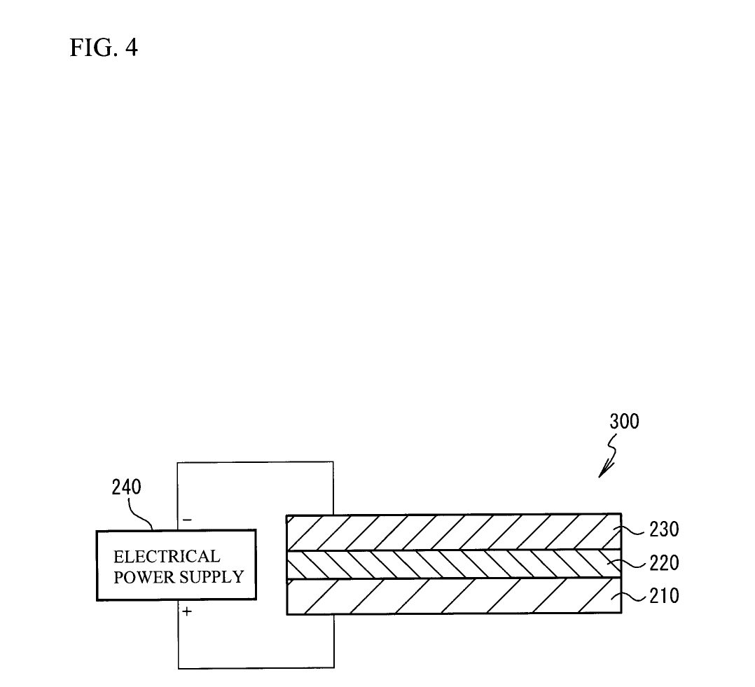

A description will be given of a hydrogen pump 300 that is another example of the electrochemical cells, in a fourth embodiment. FIG. 4 illustrates a schematic view of the hydrogen pump 300. As shown in FIG. 4, the hydrogen pump 300 has an anode 210, an electrolyte membrane 220, a cathode 230 and an electrical power supply 240. The anode 210, the electrolyte membrane 220 and the cathode 230 are laminated in order. The anode 210 is electrically coupled to a plus terminal of the electrical power supply 240. On the other hand, the cathode 230 is electrically coupled to a minus terminal of the electrical power supply 240. The electrolyte membrane 220 is made of the proton conductor 10 in accordance with the first embodiment.

Some hydrogen is converted into electrons and protons at the anode 210, when the electrical power supply 240 applies a voltage to the anode 210 and the cathode 230. The electrons move to the electrical power supply 240. The protons are conducted in the electrolyte membrane 220, and gets to the cathode 230. At the cathode 230, protons react with the electrons provided from the electrical power supply 240. Thus, hydrogen gas is generated. Therefore, the use of the hydrogen pump 300 permits a separation of hydrogen from gas provided to the anode side and a movement of the hydrogen to the cathode side. Consequently, hydrogen gas having high purity is obtained.

Valence of a transition metal included in the electrolyte membrane 220 is reduced in a pumping process of hydrogen, because the electrolyte membrane 220 is subjected to a reducing atmosphere. Therefore, protons tend to be introduced into the electrolyte membrane 220. Consequently, the hydrogen pump 300 has high protonation efficiency.

### EXAMPLES

### First Example Through Third Example

In a first example through a third example, SrZrRuO₃ proton conductors were manufactured. Table 1 shows each composition of the proton conductors. The proton conductors were made from SrCO₃, ZrO₂ and RuO₂ with a solid reaction method. SrCO₃, ZrO₂ and RuO₂ were mixed in ethanol in an alumina mortar, and were sintered (1350 degrees C. and 10 hours). Sintered powders were crushed in a ball mill (300 rpm and one hour), and were formed to be a disk shape (CIP: 300 MPa). The formed disk was baked at 1700 degrees C. for 10 hours. Thus, the sintered proton conductors were obtained.

TABLE 1

| | Composition |
|---|---|
| First Example | SrZr_{0.95}Ru_{0.05}O_{3-α} |
| Second Example | SrZr_{0.90}Ru_{0.10}O_{3-α} |
| Third Example | SrZr_{0.85}Ru_{0.15}O_{3-α} |

### (First Analysis)

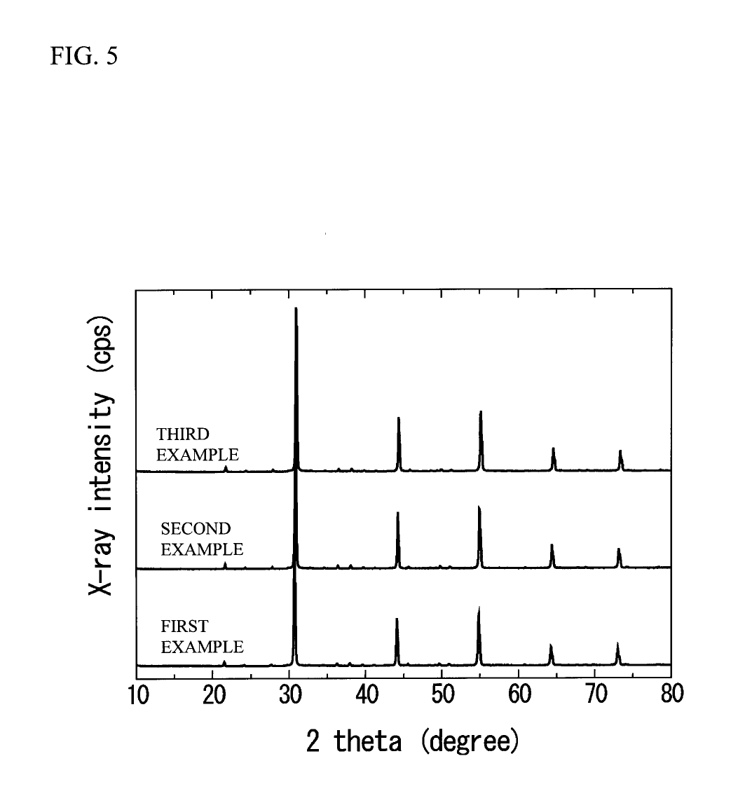

Crystal structure was measured with respect to the proton conductors of the first example through the third example, with XRD measuring. FIG. 5 illustrates a result of the XRD measuring. In FIG. 5, a vertical axis indicates XRD intensity, and a horizontal axis indicates diffraction angle. As shown in FIG. 5, a single phase of perovskite was obtained in any of the proton conductors. A peak was shifted to higher angle side, as a doping amount of Ru was more increased.

### (Second Analysis)

Electrical conductivity was measured with respect to the proton conductors of the first example through the third example. A direct-current four-terminals method was used in order to measure the electrical conductivity. The electrical conductivity of the proton conductors was measured in a rising temperature process from 107 degrees C. to 909 degrees C. and in a falling temperature process from 909 degrees C. to 107 degrees C. Temperature rising speed and temperature falling speed were set to be 100 degrees C/h. The electrical conductivity of the proton conductors was measured twice every 30 minutes. Moist hydrogen (P_{H2O}=1.9×10³ Pa) was used as an introduced gas.

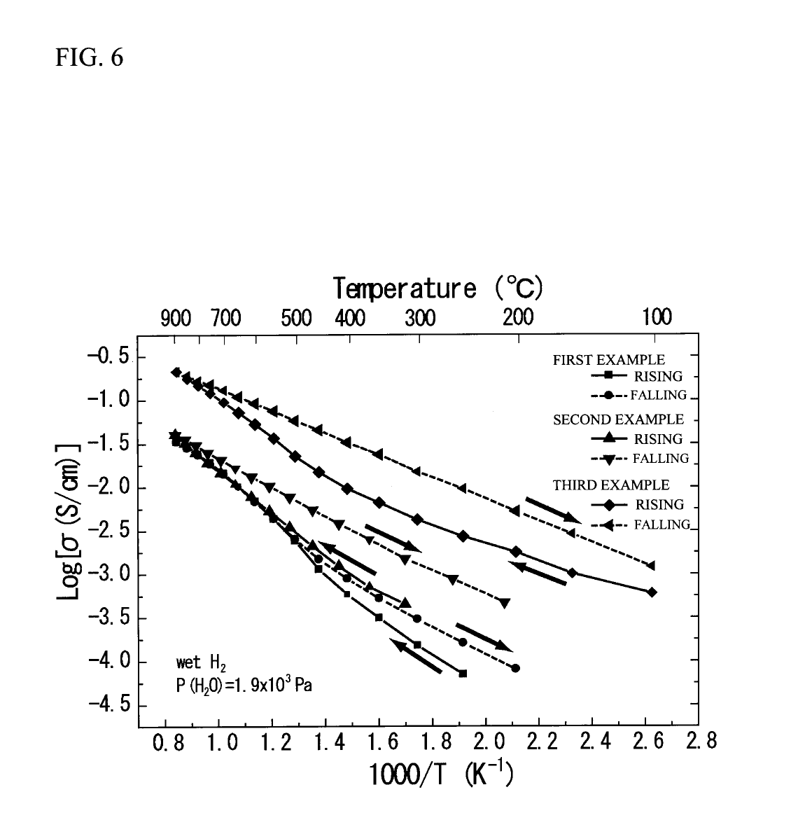

FIG. 6 illustrates the electrical conductivity of the proton conductors in the temperature rising process and in the temperature falling process. In FIG. 6, a vertical axis indicates logarithm of the electrical conductivity (S/cm), and a horizontal axis indicates reciprocal number of absolute temperature (1/K). Each of the electrical conductivity was measured in the moist hydrogen. As shown in FIG. 6, high electrical conductivity was obtained in any temperature range. And the electrical conductivity in the temperature falling process was higher than that in the temperature rising process.

### (Third Analysis)

Next, electromotive force was measured with respect to an oxygen concentration cell including the proton conductor of the second example. The proton conductor of the second example was subjected to an Ar atmosphere including 1% H₂ at 900 degrees C. overnight, before the measurement of the electromotive force. After that, each face of the proton conductor was coated with platinum paste (TR-7907 made by Tanaka Noble Metal Ltd.) with a screen print method. And the platinum paste was baked at 1050 degrees C. for two hours. The thickness of the proton conductor of the second example was 0.5 mm.

Table 2 shows an amount of gas used for the measurement and the measured electromotive force. Gas (1) was provided to one of the electrodes and gas (2) was provided to the other. A moisture partial pressure of the gas (1) and the gas (2) was set to be 1.9×10³ Pa. Temperature in the measurement was set to be 900 degrees C. As shown in Table 2, the electromotive force was not detected in any gas conditions. It is therefore thought that a movable object contributing to the electrical conductivity is other than oxygen ion. The same effect may be obtained even if the proton conductor of the first example and the third example is used.

TABLE 2

| | | Electromotive |
|---|---|---|
| Gas(1) | Gas(2) | force (mV) |
| Ar: 30 ml/min | O₂: 100 ml/min Ar: 0 ml/min | 0.0 |
| Ar: 30 ml/min | O₂: 75 ml/min Ar: 25 ml/min | 0.0 |
| Ar: 30 ml/min | O₂: 50 ml/min Ar: 50 ml/min | 0.0 |
| Ar: 30 ml/min | O₂: 25 ml/min Ar: 75 ml/min | 0.0 |
| Ar: 30 ml/min | O₂: 0 ml/min Ar: 100 ml/min | 0.0 |

### (Fourth Analysis)

Next, electromotive force was measured with respect to a hydrogen concentration cell including the proton conductor of the second example. The hydrogen concentration cell has the same structure of that of the oxygen concentration cell used in the third analysis. Table 3 shows an amount of gas used for the measurement. Gas (3) was provided to one of the electrodes and gas (4) was provided to the other. A moisture partial pressure of the gas (3) and the gas (4) was set to be 1.9×10³ Pa. Temperature in the measurement was set to be 500 degrees C. to 900 degrees C.

TABLE 3

| Gas(3) | Gas(4) |
|---|---|
| H₂: 100 ml/min Ar: 0 ml/min | 1%H₂—Ar: 30 ml/min |
| H₂: 75 ml/min Ar: 25 ml/min | 1%H₂—Ar: 30 ml/min |
| H₂: 50 ml/min Ar: 50 ml/min | 1%H₂—Ar: 30 ml/min |
| H₂: 25 ml/min Ar: 75 ml/min | 1%H₂—Ar: 30 ml/min |
| H₂: 5 ml/min Ar: 95 ml/min | 1%H₂—Ar: 30 ml/min |
| 1%H₂—Ar: 100 ml/min | 1%H₂—Ar: 30 ml/min |

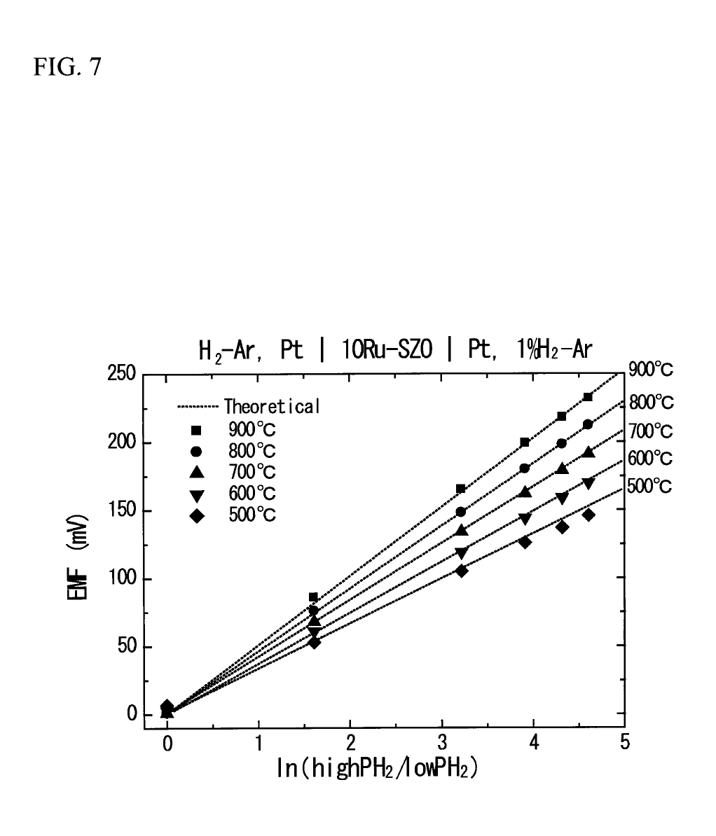

FIG. 7 illustrates the measured result. In FIG. 7, a vertical axis indicates electromotive force, and horizontal axis indicates a ratio of hydrogen partial pressure in the gas (3) against the hydrogen partial pressure in the gas (4). As shown in FIG. 7, each electromotive force approximately corresponds to theoretical value, in the hydrogen concentration cell. It is therefore thought that the proton conductor of the second example has proton transference number of approximately 1. The same effect may be obtained even if the proton conductor of the first example and the third example is used.

### (Fifth Analysis)

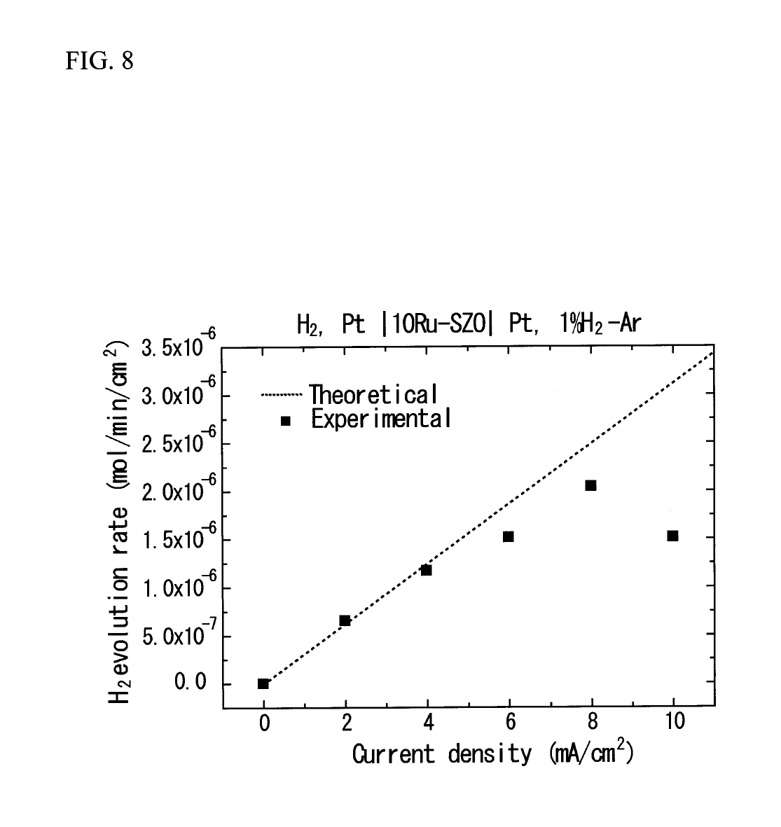

Next, hydrogen pump examination was carried out with respect to the proton conductor of the second example. A device used in this analysis has the same structure as the oxygen concentration cell used in the third analysis. H₂ of 100 ml/min was provided to the anode. 1% H₂—Ar of 30 ml/min was provided to the cathode. Temperature in the measurement was set to be 900 degrees C. FIG. 8 illustrates the measured result. In FIG. 8, a vertical axis indicates hydrogen evolution rate, and a horizontal axis indicates a current density.

As shown in FIG. 8, the hydrogen evolution rate was along theoretical value in an electrical current density range less than 4 mA/cm². In an electrical current density range more than 4 mA/cm², it is thought that at least one of the electrodes was peeled, because electrical potential between the anode and the cathode was increased or reduced. It is through that high temperature is one of causes.

According to the results of the third analysis through the fifth analysis, it is thought that the movable object in the proton conductors of the first example through the third example is proton. It is therefore thought that the proton conduction contributes to the electrical conductivity obtained in the second analysis. Consequently, it is thought that the proton conductors of the first example through the third example have high proton conductivity. This is because protons were sufficiently introduced into the proton conductor with the valence changing of Ru, in the proton conductors of the first example through the third example.

### (Sixth Analysis)

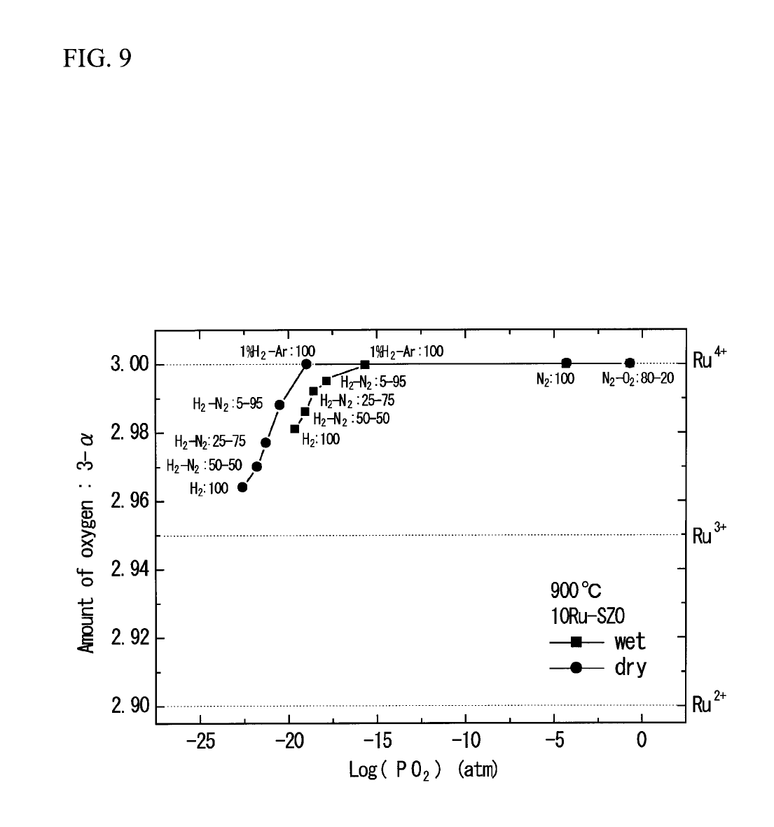

Next, oxygen nonstoichiometric amount of the proton conductor of the second example was measured. Table 4 shows measuring conditions. Temperature in the measurement was set to be 900 degrees C. Thermobalance device was used in order to measure weight of the proton conductor. FIG. 9 illustrates measured result. In FIG. 9, a vertical axis indicates the oxygen nonstoichiometric amount of the proton conductor, and a horizontal axis indicates an oxygen partial pressure.

TABLE 4

| | Sample | | Weight | Nonstoi- | |
|---|---|---|---|---|---|
| | weight | time | change | chiometric | Oxygen |
| | (mg) | (min) | (mg) | Amount | amount |
| Gas (17 degrees C. | | | | | |
| Sat.) | | | | | |
| N₂ + O₂: 80 + 20 | 238.54 | 600 | 0.00 | 0.000 | 3.000 |
| N₂: 100 | 238.58 | 250 | 0.00 | 0.000 | 3.000 |
| 1%H₂—Ar: 100 | 238.6 | 300 | 0.00 | 0.000 | 3.000 |
| H₂ + N₂: 5 + 95 | 238.45 | 800 | −0.09 | −0.005 | 2.995 |
| H₂ + N₂: 25 + 75 | 238.4 | 600 | −0.14 | −0.008 | 2.992 |
| H₂ + N₂: 50 + 50 | 238.31 | 850 | −0.23 | −0.014 | 2.986 |
| H₂: 100 | 238.23 | 650 | −0.31 | −0.019 | 2.981 |
| Gas(Dry) | | | | | |
| N₂ + O₂: 80 + 20 | 238.56 | 2000 | 0.00 | 0.000 | 3.000 |
| N₂: 100 | 238.62 | 500 | 0.00 | 0.000 | 3.000 |
| 1%H₂—Ar: 100 | 238.61 | 1000 | 0.00 | 0.000 | 3.000 |
| H₂ + N₂: 5 + 95 | 238.36 | 675 | −0.20 | −0.012 | 2.988 |
| H₂ + N₂: 25 + 75 | 238.23 | 750 | −0.39 | −0.023 | 2.977 |
| H₂ + N₂: 50 + 50 | 238.12 | 720 | −0.50 | −0.030 | 2.970 |
| H₂: 100 | 238.02 | 780 | −0.60 | −0.036 | 2.964 |

As shown in FIG. 9, the oxygen nonstoichiometric amount of the proton conductor changed according to the measuring condition. Therefore, the valence of Ru changed according to the surroundings.

### Fourth Example Through Sixth Example

In a fourth example, SrZrTbO₃ proton conductor was manufactured. The proton conductor of the fourth example was made from SrCO₃, ZrO₂ and Tb₄O₇ with a solid reaction method. In a fifth example, SrZrMnO₃ proton conductor was manufactured. The proton conductor of the fifth example was made from SrCO₃, ZrO₂ and MnO₂ with a solid reaction method. In a sixth example, SrZrPrO₃ proton conductor was manufactured. The proton conductor of the sixth example was made from SrCO₃, ZrO₂ and Pr₆O₁₁ with a solid reaction method.

Table 5 shows each composition of the proton conductors. Each material was mixed in ethanol in an alumina mortar, and was sintered (1350 degrees C. and 10 hours). Sintered powders were crushed in a ball mill (300 rpm and one hour), and were formed to be a disk shape (CIP: 300 MPa). The formed disk was baked at 1700 degrees C. for 10 hours. Thus, the sintered proton conductors were obtained.

TABLE 5

| | Composition |
|---|---|
| Fourth Example | SrZr_{0.9}Tb_{0.1}O_{3-α} |
| Fifth Example | SrZr_{0.9}Mn_{0.1}O_{3-α} |
| Sixth Example | SrZr_{0.9}Pr_{0.1}O_{3-α} |

### (Seventh Analysis)

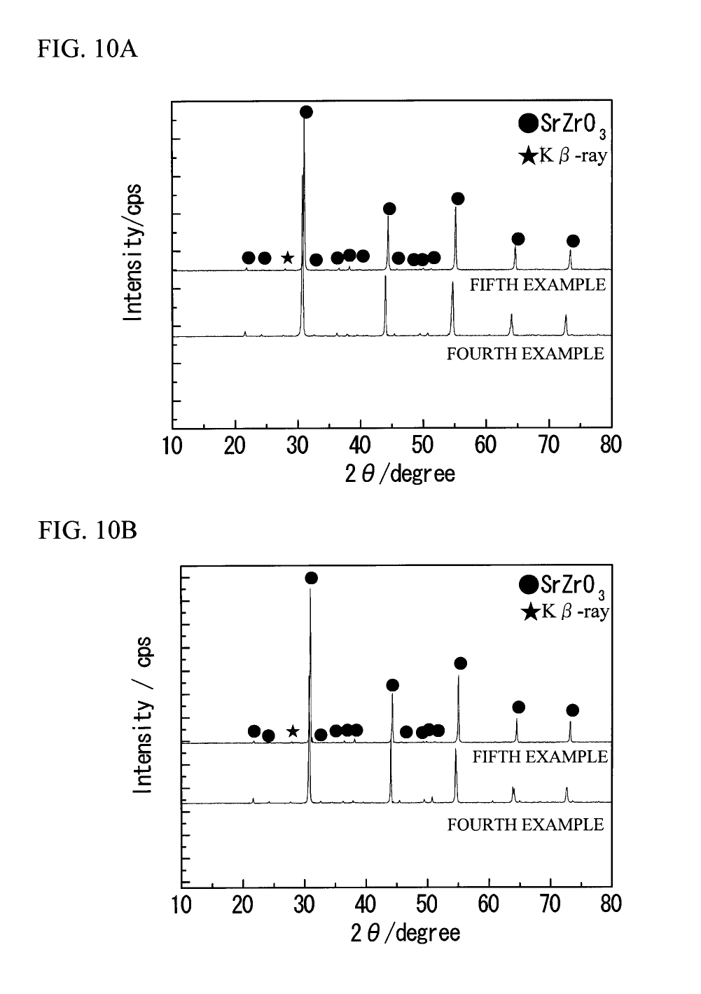

Crystal structure was measured with respect to the proton conductors of the fourth example and the fifth example with XRD measuring. FIG. 10A and FIG. 10B illustrate a result of the XRD measuring. FIG. 10A illustrates a result of the XRD measuring of each proton conductor that was placed in an air after the sintering. FIG. 10B illustrates a result of the XRD measuring of each proton conductor that was annealed in moist hydrogen atmosphere for ten hours. In FIG. 10A and FIG. 10B, a vertical axis indicates XRD intensity, and a horizontal axis indicates diffraction angle. As shown in FIG. 10A and FIG. 10B, a single phase of perovskite was obtained in any of the proton conductors.

### (Eighth Analysis)

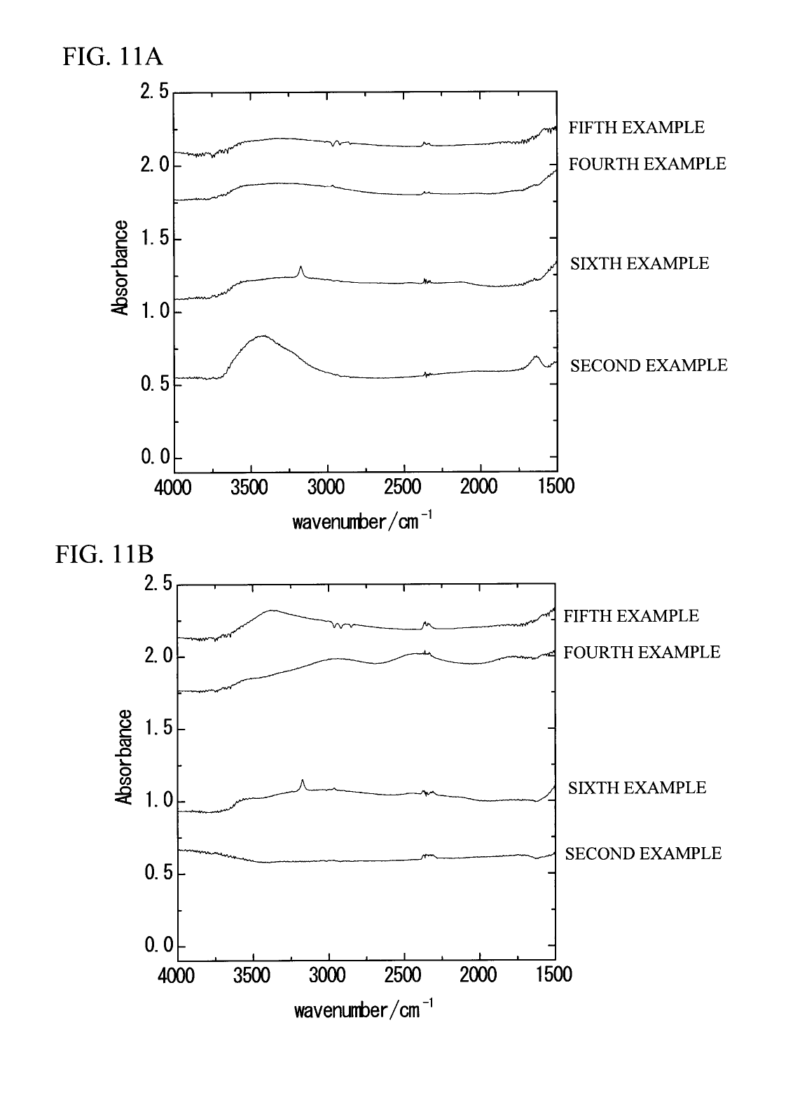

Next, proton introduction was measured with respect to the proton conductors of the fourth example through the sixth example with IR measuring. FIG. 11A and FIG. 11B illustrate a result of the IR measuring. FIG. 11A illustrates a result of the IR measuring of each proton conductor that was placed in an air after the sintering. FIG. 11B illustrates a result of the IR measuring of each proton conductor that was annealed in moist hydrogen atmosphere for ten hours. In FIG. 11A and FIG. 11B, a vertical axis indicates light-absorption, and a horizontal axis indicates wavelength.

As shown in FIG. 11A and FIG. 11B, peak intensity was more increased in FIG. 11B than in FIG. 11A, in each of the proton conductors. Therefore, protons were introduced into each of the proton conductors by annealing the proton conductor in the moist hydrogen.

### (Ninth Example)

Next, electrical conductivity was measured with respect to the proton conductors of the fourth example and the fifth example. A direct-current four-terminals method was used in order to measure the electrical conductivity. The electrical conductivity of the proton conductors was measured in a rising temperature process and in a falling temperature process. Temperature rising speed and temperature falling speed were set to be 100 degrees C/h. The electrical conductivity of the proton conductors was measured twice every 30 minutes. Moist hydrogen (P_{H2O}=1.9×10³ Pa) was used as an introduced gas.

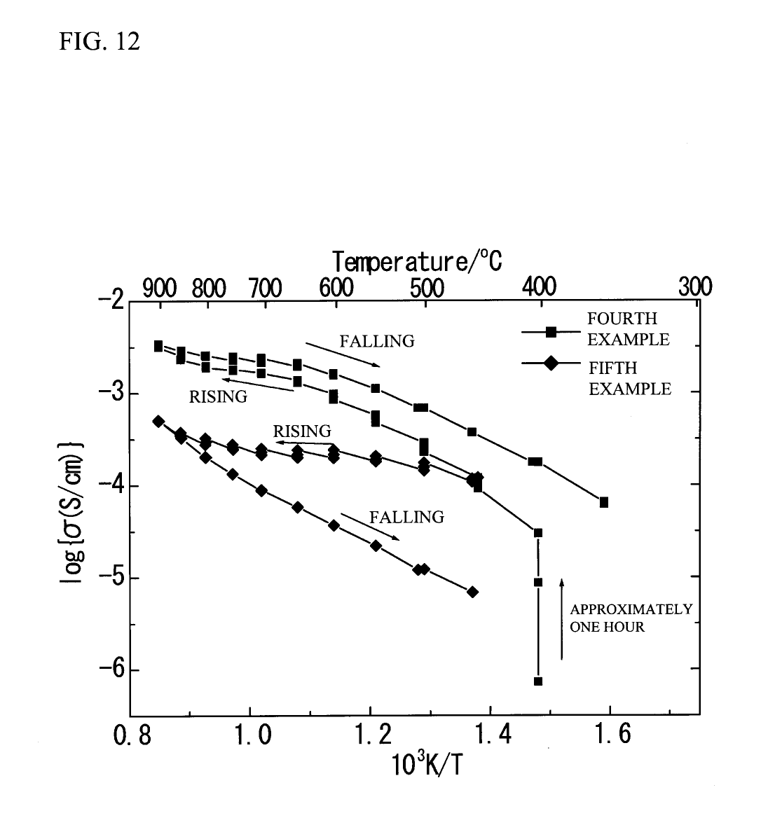

FIG. 12 illustrates the electrical conductivity of the proton conductors in the temperature rising process and the temperature falling process. In FIG. 12, a vertical axis indicates logarithm of the electrical conductivity (S/cm), and a horizontal axis indicates reciprocal number of absolute temperature (1/K). Each of the electrical conductivity was measured in the moist hydrogen. As shown in FIG. 12, high electrical conductivity was obtained in any temperature range. The electrical conductivity of the proton conductor of the fourth example was increased drastically at 400 degrees C. This is because the valence of the Tb changed to +3 from +4 and protons were introduced into the proton conductors.

### Seventh Example Through Ninth Example

In a seventh example through a ninth example, SrZrTbRuO₃ proton conductors were manufactured. Table 6 shows each composition of the proton conductors. The proton conductors were made from SrCO₃, ZrO₂, Tb₄O₇, and RuO₂ with a solid reaction method. SrCO₃, ZrO₂, Tb₄O₇ and RuO₂ were mixed in ethanol in an alumina mortar, and were sintered (1350 degrees C. and 10 hours). Sintered powders were crushed in a ball mill (300 rpm and one hour), and were formed to be a disk shape (CIP: 300 MPa). The formed disk was baked at 1700 degrees C. for 10 hours. Thus, the sintered proton conductors were obtained.

TABLE 6

| | Composition | x |
|---|---|---|
| Seventh Example | SrZr_{0.9-x}Tb_{0.1}RuₓO_{3-α} | 0 |
| Eighth Example | SrZr_{0.9-x}Tb_{0.1}RuₓO_{3-α} | 0.01 |
| Ninth Example | SrZr_{0.9-x}Tb_{0.1}RuₓO_{3-α} | 0.05 |

### (Tenth Analysis)

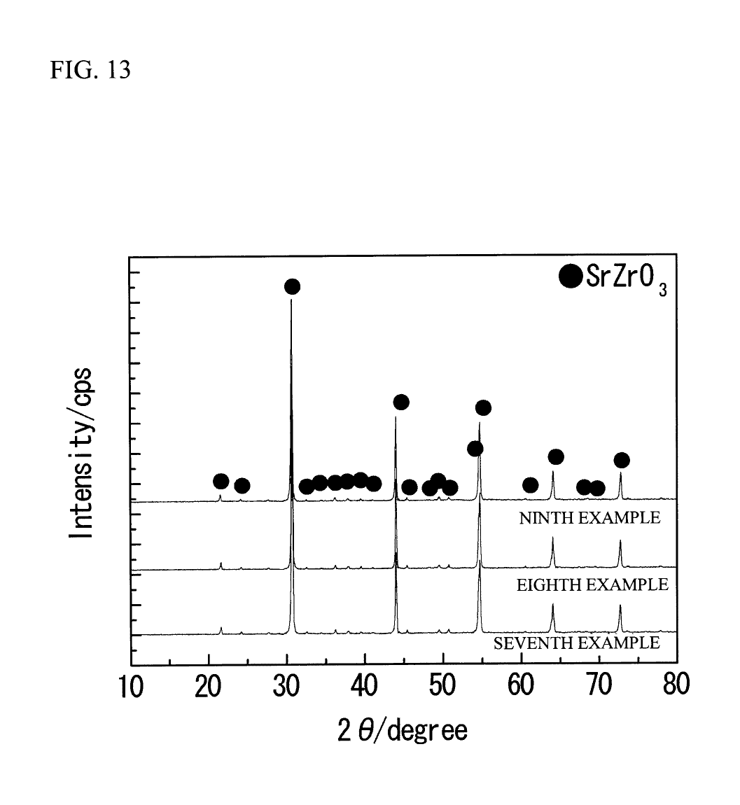

Crystal structure was measured with respect to the proton conductors of the seventh example through the ninth example with XRD measuring. FIG. 13 illustrates a result of the XRD measuring. In FIG. 13, a vertical axis indicates XRD intensity, and a horizontal axis indicates diffraction angle. As shown in FIG. 13, a single phase of perovskite was obtained in any of the proton conductors.

### (Eleventh Analysis)

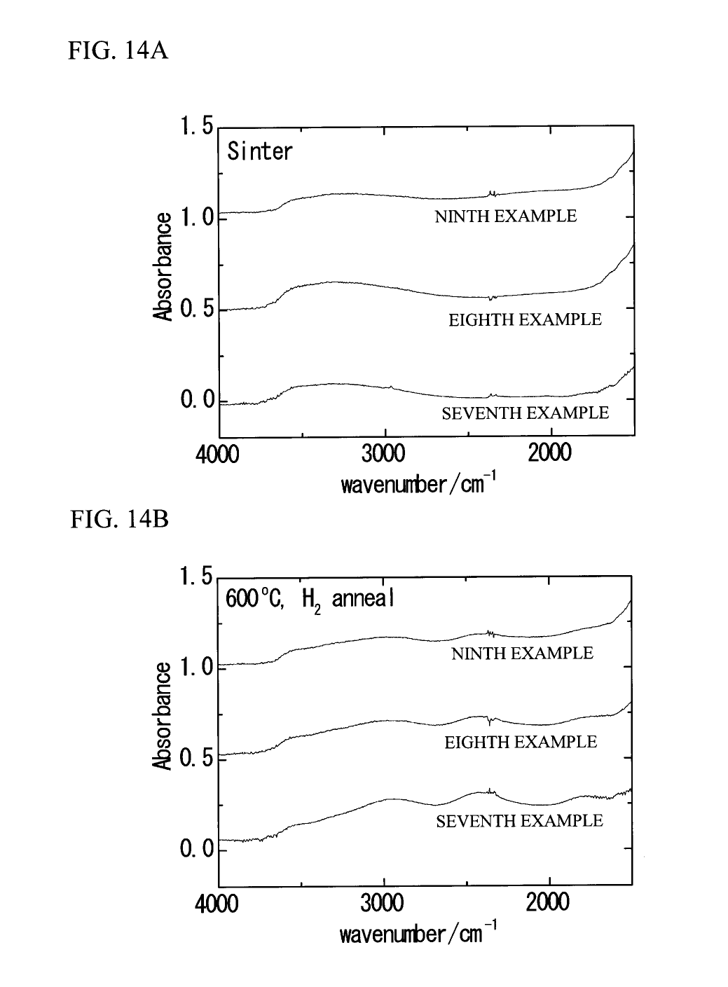

Next, proton introduction was measured with respect to the proton conductors of the seventh example through the ninth example with IR measuring. FIG. 14A and FIG. 14B illustrate a result of the IR measuring. FIG. 14A illustrates a result of the IR measuring of each proton conductor that was placed in an air after the sintering. FIG. 14B illustrates a result of the IR measuring of each proton conductor that was annealed in moist hydrogen atmosphere for ten hours. In FIG. 14A and FIG. 14B, a vertical axis indicates light-absorption, and a horizontal axis indicates wavelength. As shown in FIG. 14A and FIG. 14B, peak caused by proton introduction is observed around 3000 cm⁻¹ and around 2300 cm⁻¹, in any proton conductors.

### (Twelfth Analysis)

Next, electrical conductivity was measured with respect to the proton conductors of the seventh example through the ninth example. A direct-current four-terminals method was used in order to measure the electrical conductivity. Temperature rising speed and temperature falling speed were set to be 100 degrees C/h. The electrical conductivity of the proton conductors was measured twice every 30 minutes. Moist hydrogen (P_{H2O}=1.9×10³ Pa) was used as an introduced gas.

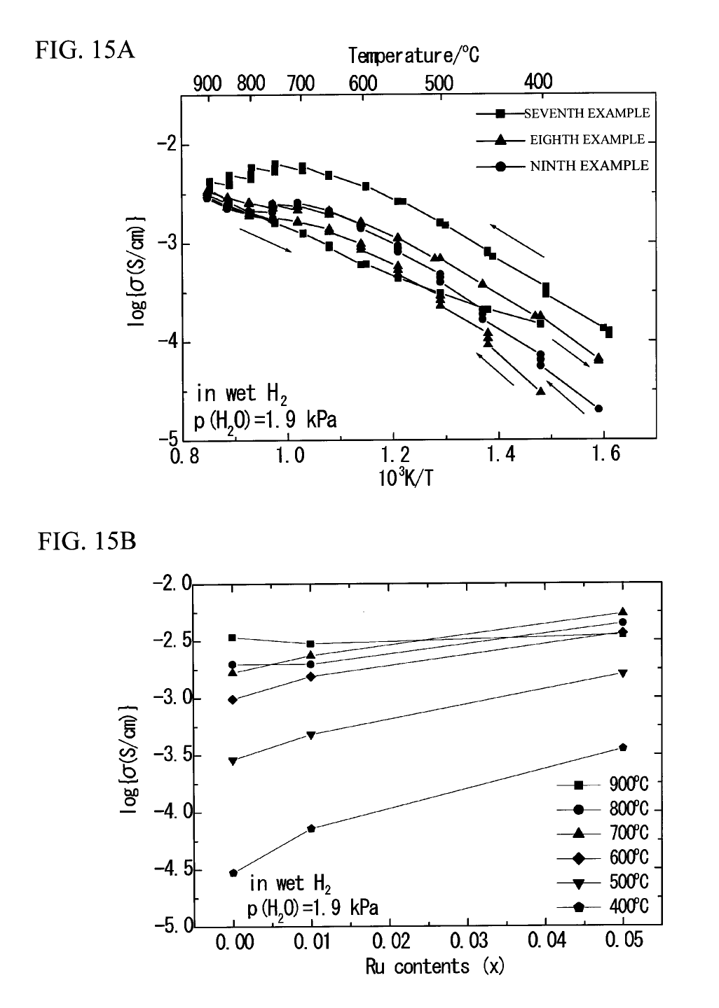

FIG. 15A and FIG. 15B illustrate the electrical conductivity of the proton conductors. In FIG. 15A, a vertical axis indicates logarithm of the electrical conductivity (S/cm), and a horizontal axis indicates reciprocal number of absolute temperature (1/K). In FIG. 15B, a vertical axis indicates logarithm of the electrical conductivity (S/cm), and a horizontal axis indicates Ru amount. Each of the electrical conductivity was measured in the moist hydrogen. As shown in FIG. 15A and FIG. 15B, high electrical conductivity was obtained in any temperature range. The electrical conductivity of the proton conductors of the eighth example and the ninth example was higher than that of the seventh example. This is because Ru doping brought hole conductivity to the proton conductor and proton introduction was promoted.

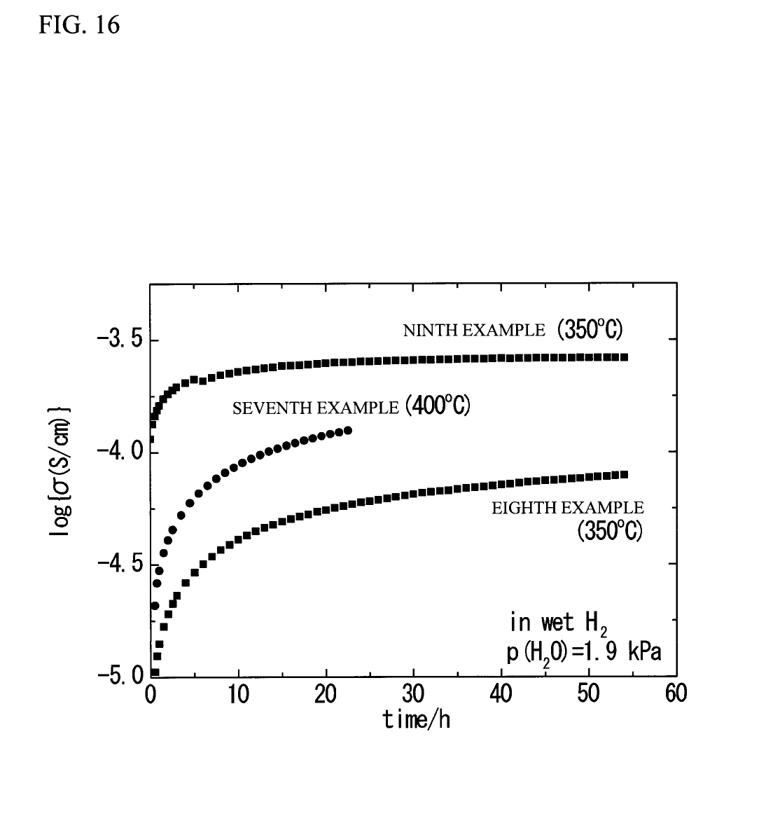

FIG. 16 illustrates a temporal change of the electrical conductivity of the proton conductors of the seventh example through the ninth example. In FIG. 16, a vertical axis indicates logarithm of the electrical conductivity (S/cm), and a horizontal axis indicates temporal change. An orientation time of the electrical conductivity of the eighth example and the ninth example were shorter than that of the seventh example. This is because the Ru doping brought hole conductivity to the proton conductor and proton introduction was promoted.

1.-14. (canceled)

15. A method of manufacturing an electrolyte for a proton conductive type fuel cell comprising a generation step of generating the electrolyte under an oxidation condition in which oxygen partial pressure is 0.01 atm or higher,
a part of a main constituent element of the electrolyte being substituted by a transition metal,
valence of the transition metal being variable between a first valence that is the same as that of the main constituent element and a second valence that is lower than the first valence,
the oxidation condition being a condition in which the valence of the transition metal is a value more than the second valence and less than the first valence.

16. (canceled)

17. The method as claimed in claim 15, wherein the generation step is a step of baking the proton conductor under an atmosphere including pressured oxygen or under an atmosphere including pressured air.

18. The method as claimed in claim 15, wherein the generation step includes an oxygen treatment step in which the proton conductor is subjected to an oxygen treatment.

19. The method as claimed in claim 18, wherein the oxygen treatment is a treatment in which the proton conductor is subjected to an oxygen atmosphere.

20. The method as claimed in claim 18, wherein the oxygen treatment is a treatment in which an anodic voltage is applied to the proton conductor under an oxygen atmosphere.

21. The method as claimed in claim 15, wherein:
the electrolyte has AB₍₁₋ₓ₎MₓO₃ perovskite structure;
the B is the main constituent element;
the M is the transition metal; and
the x is a value of 0.05 to 0.15.

22. The method as claimed in claim 15. wherein the electrolyte is one of SrZrRu, SrZrTbRu and SrZrMn.
